(19) United States
(12) Patent Application Publication
(10) Pub. No.: US 2020/0198420 A1
(43) Pub. Date: Jun. 25, 2020

(54) AUTOMATIC LOCKING DRAWBAR COUPLING

(71) Applicant: LOHR ELECTROMECANIQUE, Hangenbieten (FR)

(72) Inventors: Daniel Scheer, Still (FR); Didier Ganter, Fegersheim (FR); Jean-Luc Andre, Molsheim (FR); Nicolas Sutter, Strasbourg (FR)

(21) Appl. No.: 16/614,688

(22) PCT Filed: Jun. 8, 2018
(86) PCT No.: PCT/EP2018/065188

§ 371 Date: Nov. 18, 2019

(30) Foreign Application Priority Data
Jun. 16, 2017 (FR) 1755523

(51) Int. Cl. B60D 1/02; B60D 1/62

(52) U.S. Cl. CPC B60D 1/025; B60D 1/26; B60D 1/62

(57) ABSTRACT

The drawbar attached to the second road vehicle comprises a coupling eye at its end, while the crossbar attached to the first road vehicle comprises a drawbar coupling intended to accept the coupling eye of the first road vehicle that locks when the two road vehicles are coupled. An automatic locking mechanism is provided to lock the coupling eye to the drawbar coupling automatically when it enters the drawbar coupling once the coupling eye and the drawbar coupling have been brought closer together.

### TECHNICAL FIELD

The present invention relates to a coupling device intended to couple two road vehicles each comprising at least two axles.

More specifically, the invention relates to a coupling device comprising a drawbar coupling secured to one vehicle and a drawbar secured to the other vehicle, where this drawbar comprises an end coupling eye intended for entering into and being locked in the drawbar coupling in order to couple the two vehicles.

### BACKGROUND OF THE DISCLOSURE

In the coupling devices intended to couple two road vehicles, it is known to equip one of the vehicles with a drawbar comprising an end coupling eye. This coupling eye is intended to enter into the drawbar coupling of another vehicle and be locked there by inserting a coupling pin in the central opening of the eye.

The insertion of the coupling eye into the drawbar coupling is generally done by movement of one vehicle to be coupled closer to the other. In contrast, the insertion of the coupling pin into the central opening of the eye is usually done manually. In addition to requiring getting out of the vehicle, this operation is finicky and requires several maneuvers by the driver when the two vehicles have not been correctly brought together so that the coupling eye goes into the drawbar coupling.

Further, this operation can be difficult and can lead to risks of injury for the operator, in particular because of the handling of heavy mechanical parts and/or by tight engagement with each other.

Likewise, the coupling devices generally do not comprise means for detecting that the coupling eye is well positioned in the drawbar coupling. Thus, not knowing whether the coupling eye is well positioned in the drawbar coupling or not, the operator must make many maneuvers with at least one of the vehicles without means of knowing whether it is well positioned or not. In case of maneuvering problem, the operator can even damage one vehicle and/or the coupling device.

Finally, the coupling devices generally do not comprise means for detecting that the coupling eye is fully locked in said drawbar coupling. In fact, if this locking is not correct, the operator may just the same be led to think that the vehicles are well coupled and travel with said vehicles, which could cause serious accidents in case of failure of the coupling.

These problems become even more critical in the case where more than two road vehicles are coupled one after the other to form a road train.

From document FR 3,044,135, a method for operating a fleet of individual electrical vehicles and also a system for management and use of a fleet of vehicles which could form a road train are known. This document discloses a coupling comprising a drawbar equipped with an eye and a drawbar coupling, but does not give any additional technical detail concerning the means practiced in this coupling.

Consequently, there is a need for a coupling device with which to address the problems previously raised.

### SUMMARY OF THE DISCLOSURE

The purpose of the present invention is consequently to remedy the disadvantages of the prior art by proposing a new coupling device comprising a drawbar coupling which automatically locks a coupling eye when the eye enters into the drawbar coupling.

Another purpose of the present invention is also to propose a new coupling device comprising means for informing the operator both that the coupling eye is well positioned in the drawbar coupling and that it is fully locked therein. Advantageously, such a coupling device can also comprise means for automatically unlocking the coupling eye.

The purposes given to the invention are achieved using a coupling device provided between a first and a second road vehicle for coupling these two road vehicles, these two road vehicles each comprising at least two axles, where said coupling device comprises:

a drawbar secured to the second road vehicle and comprising an end coupling eye; and

a crossbar secured to the first road vehicle and comprising a drawbar coupling intended to receive the coupling eye of the first road vehicle for locking during coupling of the two road vehicles;

where said coupling device is characterized in that it comprises an automatic locking mechanism provided for automatically locking the coupling eye with the drawbar coupling when it enters into the drawbar coupling following the coupling eye and the drawbar coupling coming close.

With this coupling device, a coupling eye can therefore be automatically locked when the eye enters into the drawbar coupling.

According to one example of implementation of the invention, the automatic locking mechanism comprises the following means:

a coupling pin provided in the crossbar of the first road vehicle, where this coupling pin is perpendicular to the drawbar when the two road vehicles are coupled and is mobile between a locked position wherein it enters into the drawbar coupling for passing through the coupling eye and an unlocked position in which it releases the coupling eye such that the eye can be extracted from the drawbar coupling;

a displacement device provided in the crossbar of the first road vehicle for moving the coupling pin between the locked position thereof and the unlocked position thereof;

a detection device provided in the crossbar of the first road vehicle for detecting the presence of the coupling eye in the drawbar coupling, where said detection device automatically actuates the displacement device when it detects the presence of the coupling eye in the drawbar coupling in order for the displacement device to move the coupling pin into the locked position thereof.

According to another example of implementation of the invention, the coupling eye is located in a vertical plane and the coupling pin is horizontal, or else the coupling eye is located in a horizontal plane and the coupling pin is vertical.

According to an additional example of implementation of the invention, the coupling device comprises a command device which, when it is actuated by a user, commands the displacement device such that it moves the coupling pin into the unlocked position thereof.

According to an example of implementation of the invention, the coupling device comprises an unlocking cable or threaded rod linked to the coupling pin and which moves the coupling pin into the unlocked position thereof when it is actuated in traction by a user.

According to another additional example of implementation of the invention, the unlocking cable or threaded rod is connected to a screw accessible to a user, where this screw causes the longitudinal movement of the cable or threaded rod for unlocking when it is turned.

According to an additional example of implementation of the invention, the displacement device comprises an elastic pushing or return device which forces the coupling pin in the direction of the drawbar coupling, the detection device comprises a blocking device which is housed in the drawbar coupling and prevents the coupling pin from entering into said drawbar coupling, where this blocking device is suited for coming into contact with the coupling eye during coupling of the two road vehicles, which would release the coupling pin which can then enter into said coupling eye within the drawbar coupling in order to mutually lock the two road vehicles. This example of implementation provides an automatic locking device.

According to an example of implementation of the invention, the blocking device comprises a mobile part in butted contact with the free end of the coupling pin, where this mobile part is kept in plugging position before the coupling pin by a second elastic pushing or return device, and where said mobile part is moved outside of the plugging position thereof when it comes into contact with the coupling eye.

According to another example of implementation of the invention, the displacement device comprises a cylinder.

According to an additional example of implementation of the invention, the cylinder is a single acting cylinder associated with a spring which pushes the rod of said cylinder into extended position and where the retracted position of the rod of the cylinder is obtained by pressurizing said cylinder. This provides an automatic locking device with positive security.

According to an example of implementation of the invention, the detection device comprises a position sensor or a mechanical device which, when it detects the presence of the coupling eye in the drawbar coupling or when it detects the proximity of said eye, causes operation of the cylinder by pushing of the coupling pin into the drawbar coupling or ends pressurizing of the cylinder if that is combined with an elastic pushing or return device, which causes the pushing of the coupling pin into the drawbar coupling.

According to another example of implementation of the invention, the coupling pin slides longitudinally in a housing comprising at least one receiving groove on the inner perimeter thereof and the coupling pin comprises at least one locking part on the outer perimeter thereof intended for freely engaging in the at least one receiving groove when the coupling pin is inserted into the coupling eye, where this engagement of the at least one locking part in the at least one receiving groove longitudinally locks the coupling pin into position.

According to an additional example of implementation of the invention, the displacement device comprises a slider which enters to the inside of the coupling pin such that, when the displacement device moves the coupling pin into the locked position thereof, the slider pushes the at least one locking part outward so as to lock it in the at least one receiving groove.

According to an example of implementation of the invention, the crossbar secured to the first road vehicle comprises a first electrical and/or fluid connection box and the drawbar secured to the second road vehicle comprises a second electrical and/or fluid connection box, where the first and second electrical and/or fluid connection boxes are intended to engage with each other during coupling of the two road vehicles. With these boxes, the vehicles can share the energy networks thereof.

According to an additional example of implementation of the invention, the first road vehicle is a towing vehicle and the second road vehicle is a following vehicle.

The purposes assigned to the invention are also achieved by means of a road vehicle comprising a coupling device such as previously described.

According to an example of implementation of the invention, said road vehicle comprises a drawbar in the front and a crossbar comprising a drawbar coupling in the back.

### BRIEF DESCRIPTION OF THE DRAWINGS

Other characteristics and advantages of the present invention will be seen more clearly from the following description, provided with reference to the appended drawings, provided by way of non-limiting examples, in which:

FIG. 1 is a three-quarter rear bottom perspective view of two road vehicles equipped with the coupling device according to the invention, where these two road vehicles are not coupled;

FIG. 2 is a perspective view similar to that of FIG. 1, in which the two road vehicles are coupled by means of a coupling device according to the invention;

FIG. 3 is a rear three-quarter top perspective view of the coupling device according to the invention in which the crossbar comprising the drawbar coupling is shown in horizontal section, whereas the drawbar is shown in vertical section;

FIG. 4 is a three-quarter top perspective view of a crossbar according to the invention shown in horizontal section;

FIGS. 5 to 7 are detailed views of the mechanical part circled in FIG. 3 showing the operation of the locking part which longitudinally locks the coupling pin into position;

FIGS. 8 to 10 are top perspective views of a coupling device according to a variant of the invention in which the detection of the presence of the coupling eye in the drawbar coupling is done mechanically; these figures show the steps of detection and locking of the coupling eye in the drawbar coupling; and

FIGS. 11 to 15 are top perspective views of a coupling device according to another variant of the invention in which the detection of the presence of the coupling eye in the drawbar coupling is done electrically; these figures show the steps of detection and locking of the coupling eye in the drawbar coupling.

### DETAILED DESCRIPTION

The structurally and functionally identical elements shown in several different figures are assigned the same numerical or alphanumerical reference.

The coupling device (1) according to the invention is intended for being positioned between a first road vehicle (2) and a second adjacent road vehicle (3) for coupling these two road vehicles (2, 3).

The expressions “first vehicle” and “second vehicle” do not translate into any relative positioning nor any role for these vehicles, but simply allows distinguishing them from each other.

According to a preferred embodiment of the invention, the first road vehicle (2) is a motorized towing vehicle which is positioned in front of the second road vehicle (3) which is a following vehicle.

The coupling device (1) according to the invention is intended to equip road vehicles (2, 3) each comprising at least two axles (4). Preferably it involves vehicles intended to transport people.

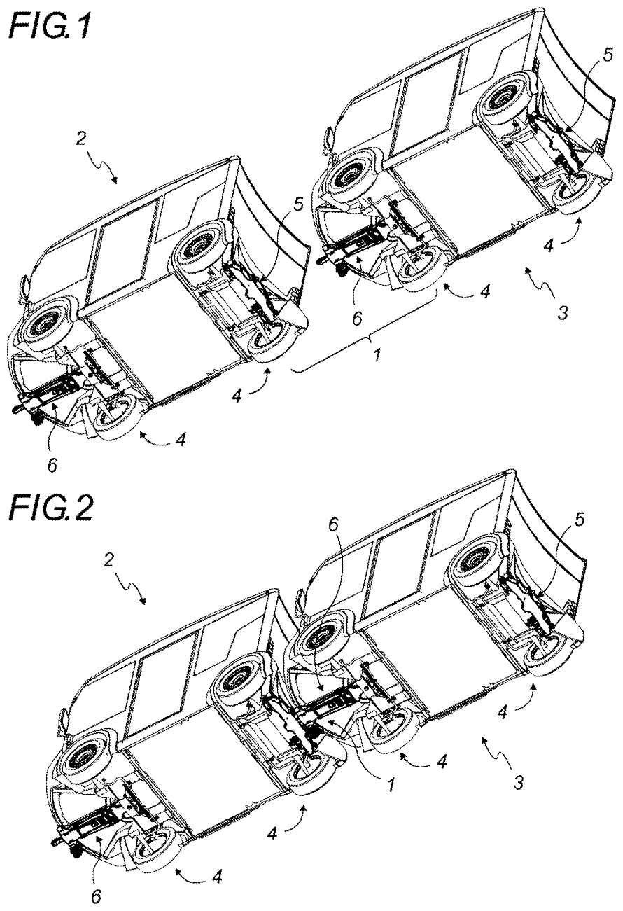

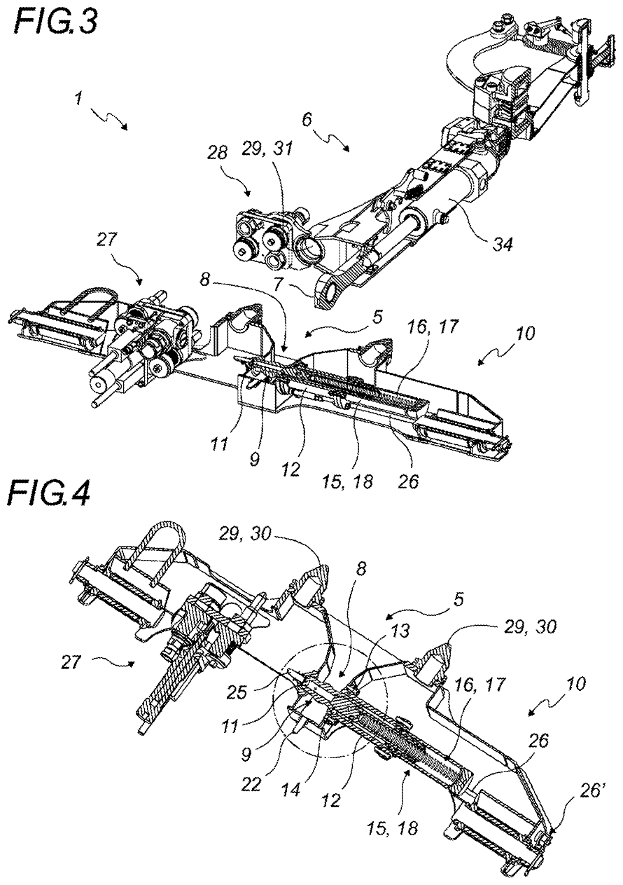

As shown in FIGS. 1 to 3, the coupling device (1) according to the invention comprises a drawbar coupling (5) secured to the first road vehicle (2) and a drawbar (6) secured to the second road vehicle (3).

According to a preferred embodiment of the invention, the first and second road vehicles (2, 3) are identical, and intended to form couplings of at least two road vehicles (2, 3) in a row one after the other in order to form a road train. Thus, the invention also relates to a unitary road vehicle (2, 3) comprising a coupling device (1) according to the invention, specifically a drawbar (6) provided at one end, for example at the front of said vehicle, and a drawbar coupling (5) provided at the opposite end, for example at the rear of said vehicle.

The drawbar (6) comprises a coupling eye (7) near the distal end thereof and the drawbar coupling (5) comprises a receiving housing (8) in which the coupling eye (7) is intended to be received and locked by a coupling pin (9) in order to couple two road vehicles (2, 3).

Here coupling eye (7) is understood to mean a female coupling part intended to be locked by a complementary male coupling part. In the figures, the female part is shown in the form of an eye through which a robust pin passes designated as coupling pin (9). Other forms can be conceived for the coupling eye (7) without going outside the scope of the invention. For example, the coupling eye (7) can have the form of a hook, a drilled plate, or a part having a hollow, while the coupling pin (9) can be intended to only partially enter into the coupling eye (7). It is easy for the person skilled in the art to provide other forms for the coupling eye (7) and the coupling pin (9) from the moment that the coupling eye (7) has the form of a female coupling part which is locked by at least partial engagement thereof with the coupling pin (9) in the form of complementary male coupling part.

In the following description, it is out of concern for clarity and convenience in reading that the female coupling part is designated as coupling eye (7) and the complementary male coupling part is designated as coupling pin (9).

The drawbar coupling (5) is preferably provided in a crossbar (10) secured to the first road vehicle (2).

The coupling device (1) according to the invention is particular in that it comprises an automatic locking mechanism provided for automatically locking the coupling eye (7) with the drawbar coupling (5) when it enters into the receiving housing (8) of the drawbar coupling (5) following the coupling eye (7) and the coupling eye (5) coming closer.

It will be noted that the coupling eye (7) can for example be provided in a horizontal or vertical plane. In the examples and embodiments of the invention shown in the figures, the orientation thereof is chosen so as to reduce the space requirements of the automatic locking mechanism of the coupling device (1). In the case where the coupling eye (7) is located in a vertical plane, the coupling pin (9) is horizontal, whereas in the case where the coupling eye (7) is located in a horizontal plane, the coupling pin (9) is vertical.

The coupling eye (7) is preferably mobile from front to rear and reciprocally, for example by the movement of one of the two road vehicles (2, 3) relative to the other and/or by the movement of the coupling eye (7) relative to the second road vehicle (3). In this case, the coupling eye (7) can be provided near the free end of the rod of a cylinder (34) housed in the drawbar (6).

The automatic locking mechanism includes a coupling pin (9) provided in the crossbar (10) of the first road vehicle (2).

This coupling pin (9) is preferably intended to be perpendicular to the drawbar (6) when the two road vehicles (2, 3) are coupled.

The coupling pin (9) is mobile between a locked position in which it enters into the drawbar coupling (5) in order to engage for locking with the coupling eye (7), for example by passing completely or partially therethrough, and an unlocked position in which it releases the coupling eye (7) such that the eye can be extracted from the drawbar coupling (5).

When the coupling pin (9) is in locked position, the two road vehicles (2, 3) are coupled and cannot be separated, whereas when the coupling pin (9) is in unlocked position, the two road vehicles (2, 3) are independent.

The coupling pin (9) preferably has the shape of a shaft whose diameter is substantially less than that of the through opening in the coupling eye (7) and whose free end (11) has a substantially rounded or conical shape so that it can enter the coupling eye (7) more easily.

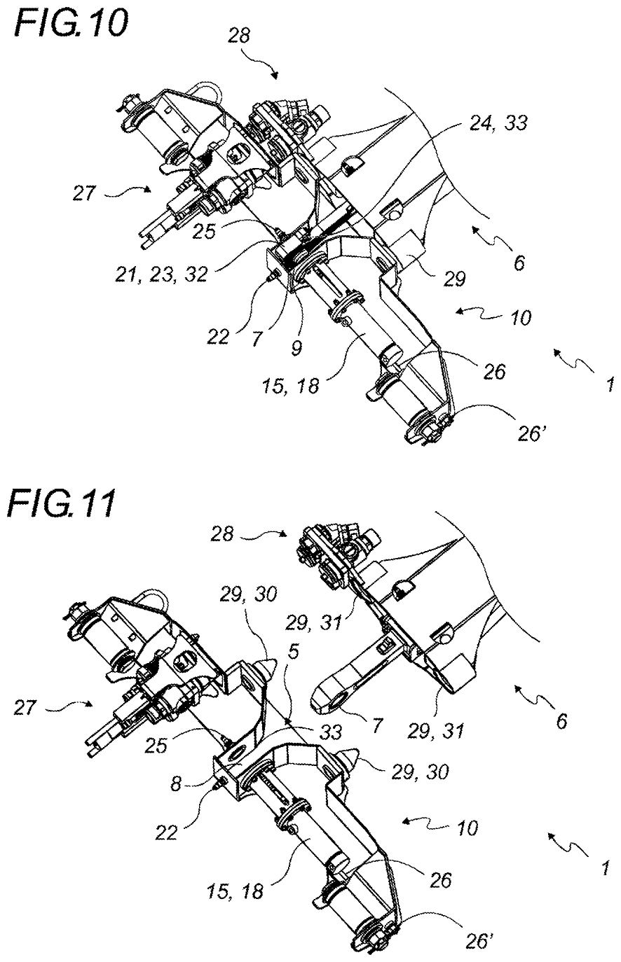

According to an embodiment of the invention shown in detail in FIGS. 5 to 7, the coupling pin (9) slides longitudinally in a housing (12) comprising at least one receiving groove (13) on its inner periphery. According to this embodiment, the coupling pin (9) comprises at least one locking part (14) on the outer perimeter thereof intended for freely engaging in the at least one receiving groove (13) when the coupling pin (9) is inserted into the coupling eye (7), where this engagement of the at least one locking part (14) in the at least one receiving groove (13) longitudinally locks the coupling pin (9) into position.

The automatic locking mechanism also comprises a displacement device (15) provided in the crossbar (10) of the first road vehicle (2) to move the coupling pin (9) between the locked position thereof and the unlocked position thereof.

According to an embodiment of the invention, the displacement device (15) comprises an elastic pushing or return device (16) which forces the coupling pin (9) towards the drawbar coupling (5). This elastic pushing or return device (16) preferably has the form of a coil spring (17).

According to another embodiment of the invention, the displacement device (15) comprises a cylinder (18) which moves the coupling pin (9) closer to or farther from the drawbar coupling (5).

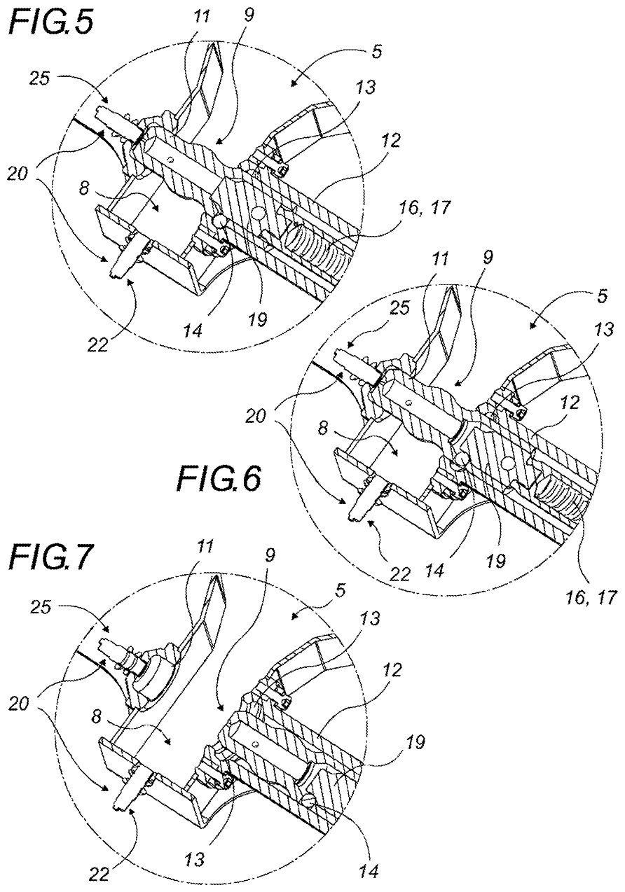

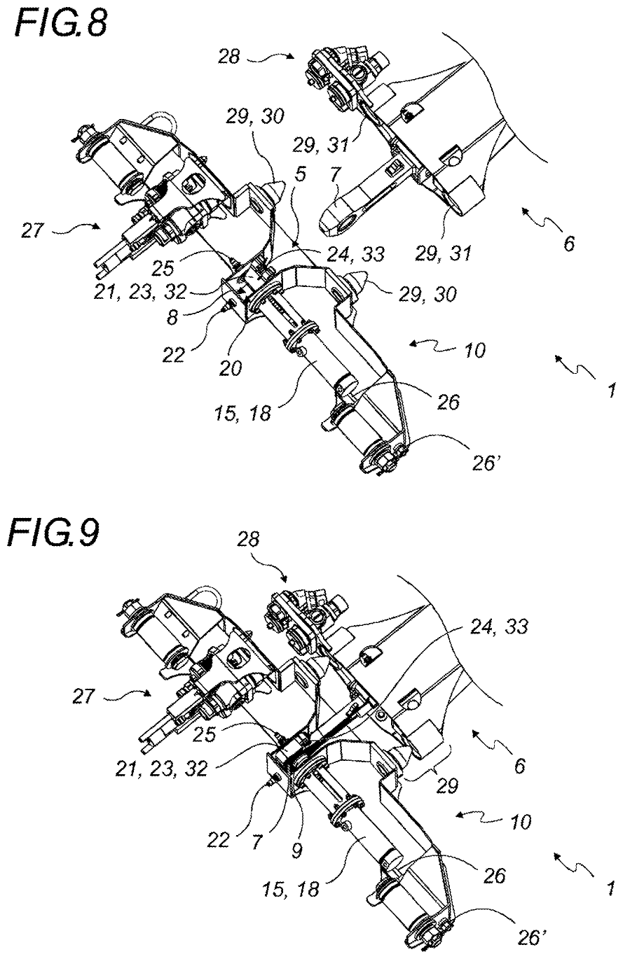

According to a variant of the preceding embodiments of the invention and shown in FIGS. 3 to 15, the cylinder (18) is a single acting cylinder associated with a spring (17) which pushes the rod of said cylinder (18) into extended position and where the retracted position of the rod of the cylinder (18) is obtained by putting said cylinder (18) under pressure. In this variant, a positive security automatic locking mechanism can be obtained in which the coupling eye (7) remains locked by the coupling pin (9) even in case of hydraulic or pneumatic failure. In fact, locking of the coupling eye (7) by the coupling pin (9) is done without supplying energy.

According to an embodiment of the invention shown in FIGS. 3 to 7 in which the coupling pin (9) slides longitudinally in a housing (12) comprising at least one receiving groove (13), the displacement device (15) comprises a slider (19) which enters to the inside of the coupling pin (9) such that, when the displacement device (15) moves the coupling pin (9) into the locked position thereof, the slider (19) pushes the at least one locking part (14) outward so as to lock it in the at least one receiving groove (13). The slider (19) preferably has a head intended to come into bearing contact against a complementary bearing surface provided inside the coupling pin (9). Said head of the slider (19) also has a peripheral groove whose usefulness is described below.

According to the implementation example of the invention shown in detail in FIGS. 5 to 7, the locking part (14) has the form of balls which are mounted radially mobile in a housing provided on the outer periphery of the coupling pin (9).

In FIG. 5, the coupling pin (9) is in a locked position and the free end (11) thereof is received in a housing equipped with a locking sensor (25) which detects that the coupling pin (9) is really in locked position. In this position, the coil spring (17) exerts a force which keeps the coupling pin (9) in the receiving housing (8) of the drawbar coupling (5). The balls project into the receiving groove (13) and prevent an untimely withdrawal of the coupling pin (9).

In FIG. 6, the cylinder (18) of the displacement device (15) is pressurized in order to separate the coupling pin (9) from the receiving housing (8) of the drawbar coupling (5) in order to move the coupling pin (9) is into unlocked position. The cylinder (18) acts on the slider (19), which up to now held the balls in the receiving groove (13). In this position, the balls are bearing on the slider (19) and cannot retract into the housing thereof provided on the outer periphery of the coupling pin (9). While the cylinder (18) moves the slider (19) backward, the balls move in the peripheral groove of the head of the slider (19). Since this zone for receiving the balls has a smaller diameter, said balls retract into the coupling pin (9).

The cylinder (18) then continues the travel thereof and in order to completely withdraw the coupling pin (9) outside the receiving housing (8) of the drawbar coupling (5).

In FIG. 7, the cylinder (18) of the displacement device (15) moved the coupling pin (9) outside the receiving housing (8) of the drawbar coupling (5). The coupling pin (9) is then in unlocked position; the drawbar coupling (5) is free to receive the coupling eye (7).

The automatic locking mechanism also comprises a detection device (20) provided in the crossbar (10) of the first road vehicle (2) in order to detect the presence of the coupling eye (7) in the drawbar coupling (5). When it detects the presence and proper positioning of the coupling eye (7) and the drawbar coupling (5) in order for locking thereof, the detection device (20) automatically actuates the displacement device (15) in order that the device moves the coupling pin (9) into the locked position thereof.

The device for detection (20) of the presence of the coupling eye (7) can be mechanical or electronic. It is also stated that the detection device (20) can be material or immaterial.

Typically, in the case where the detection device (20) is mechanical, a mobile part (21) is housed in the drawbar coupling (5) and displaced by the penetration of the coupling eye (7) into the drawbar coupling (5). When the coupling eye (7) is in the adequate position for locking thereof, the movement of said mobile part (21) then actuates the displacement device (15) for locking the coupling eye (7).

Typically, in the case where the detection device (20) is electronic, at least one position sensor (22) detects the presence of the coupling eye (7) in the drawbar coupling (5) and, when this at least one position sensor (22) detects that the coupling eye (7) is in the adequate position in order for locking thereof, it actuates the displacement device (15). This actuation can be indirect. In fact, the at least one position sensor (22) can be connected to one electronic board and/or to one computer processing device which processes the information coming from each of the position sensors (22) and which in particular guides the displacement device (15), at least in locking of the coupling eye (7). The at least one position sensor (22) may for example be a contact sensor, a magnetic sensor, an optical sensor or an inductive sensor. It can be intended for detecting the proximity or the presence of the coupling eye (7) in the drawbar coupling (5).

Of course, the detection device (20) may combine several detection means, including mechanical and electronic means.

The detection device (20) may comprise a blocking device (23) which is housed in the drawbar coupling (5) and prevents the coupling pin (9) from entering into said drawbar coupling (5). This blocking device (23) is suited for coming into contact with the coupling eye (7) when this eye is moved into the drawbar coupling (5), in order for the coupling of the two road vehicles (2, 3). The blocking device (23) is then pulled back and no longer prevents the coupling pin (9) from entering into said drawbar coupling (5), which releases the coupling pin (9) which can then enter into the coupling eye (7) within the drawbar coupling (5) in order to mutually lock the two road vehicles (2, 3) road.

Such a blocking device (23) is in particular of interest when the coupling pin (9) is naturally pushed in the direction of the drawbar coupling (5), for example by a spring. Indeed, the automatic withdrawal of the blocking device (23) when the coupling eye (7) is moved into the drawbar coupling (5) allows a locking that is automatic without applying energy from the coupling eye (7) by the coupling pin (9).

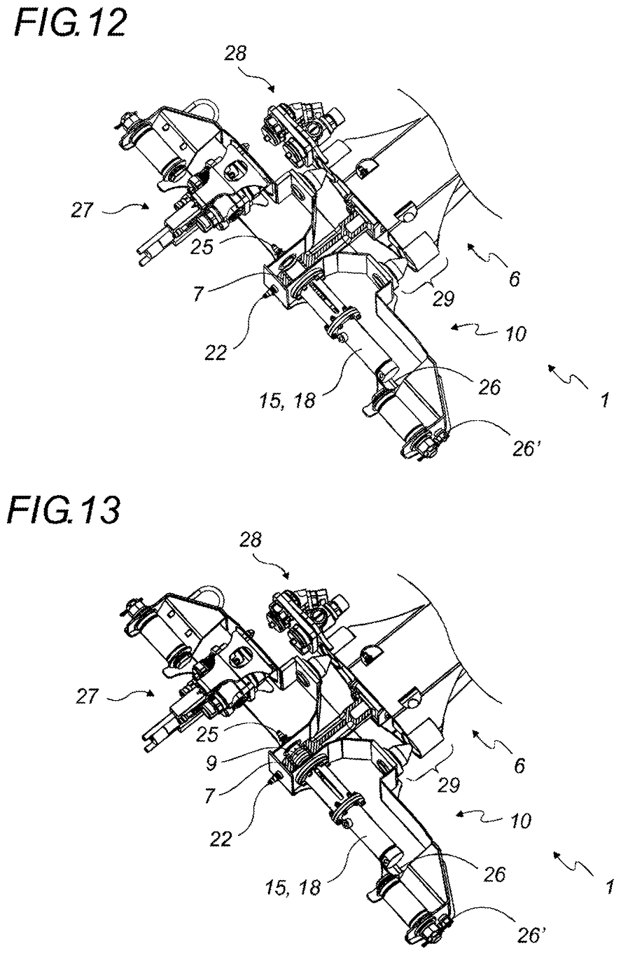

As an example, according to an embodiment of the invention shown in FIGS. 8 to 10 and in which the detection device (20) is mechanical, the blocking device (23) comprises a mobile part (21), having the shape of a swinging flap (32), whose sides are in butted contact with the free end (11) of the coupling pin (9), where this mobile part (21) is held in blocking position in front of the mobile pin (9) by a second elastic pushing or return device (24), where said mobile part (21) is moved outside of the blocking position when it comes into contact with the coupling eye (7) and it is properly positioned in the drawbar coupling (5) in order for locking thereof.

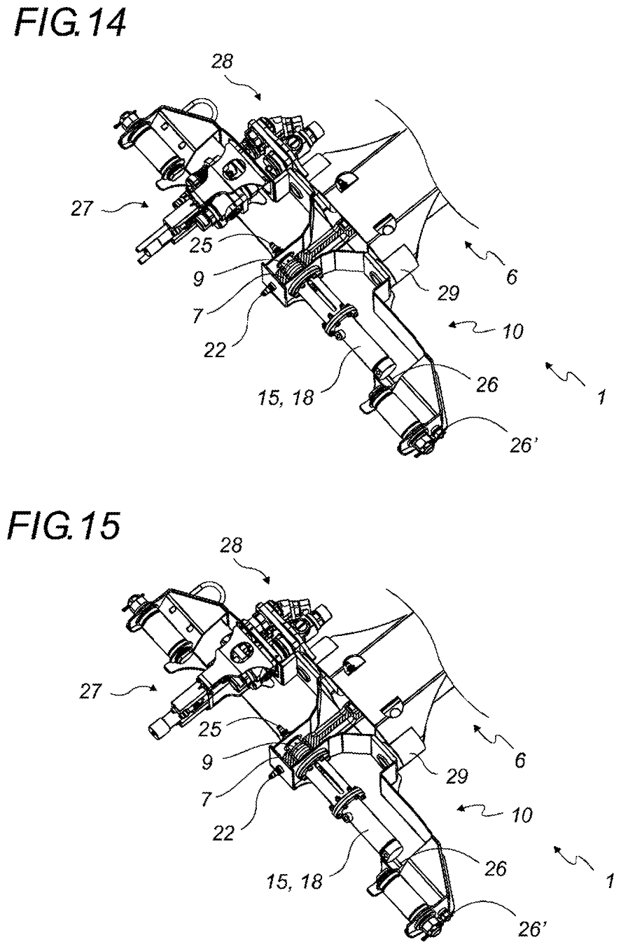

According to another embodiment of the invention shown as an example in FIGS. 11 to 15 and in which the detection device (20) is electronic, the displacement device (15) comprises a cylinder (18) whose mobile rod is pushed towards the drawbar coupling (5) by an elastic pushing or return device (16) in the form of a coil spring (17), where the mobile rod of said cylinder (18) is separated from the drawbar coupling (5) by pressurizing the cylinder (18). According to this embodiment, the detection device (20) comprises a position sensor (22) or a mechanical device which, when it detects the presence of the coupling (7) in the drawbar coupling (5) or when it detects the proximity of said coupling eye (7) ends pressurizing of the cylinder (18), which causes the pushing of the coupling pin (9) into the drawbar coupling (5).

The detection device (20) preferably also comprises at least one locking sensor (25), which detects that the coupling eye (7) is correctly locked by the coupling pin (9).

In order to be able to unlock the automatic locking mechanism, this mechanism may comprise means for extracting the coupling pin (9) outside of the coupling eye (7). These means are preferably actuated remotely.

According to an embodiment of the invention, the automatic locking mechanism comprises a command device which, when it is actuated by a user, commands the displacement device (15) such that it moves the coupling pin (9) into the unlocked position thereof. For example, in the case where the displacement device (15) comprises a single acting cylinder (18) combined with a spring (17) which pushes the rod of said cylinder (18) into extended position, actuating the command device drives the pressurizing of the cylinder (18) which causes the disengagement of the coupling pin (9) relative to the coupling eye (7) and which separates the two road vehicles (2, 3).

According to another embodiment of the invention, the automatic locking mechanism comprises an unlocking cable or threaded rod (26) linked to the coupling pin (9) and which moves the coupling pin (9) into the unlocked position thereof when it is actuated by a user, in traction for the cable or in rotation for the threaded rod (26). This actuation and traction can be done manually, for example using a handle equipping the free end of the unlocking cable; it can also be assisted by a mechanical or motorized device. According to a preferred variant, the threaded rod (26) is received in rotation in a threaded screw (26′) accessible to the user from outside the vehicle, where this screw causes the longitudinal displacement of the threaded rod (26) when it is turned. Of course, the unlocking cable or threaded rod (26) can be replaced by a linkage system or any system with which to remotely move the coupling pin (9) disengaging the coupling eye (7).

According to an embodiment of the invention shown in FIGS. 3 and 8 to 15, the crossbar (10) secured to the first road vehicle (2) and the drawbar (6) secured to the second road vehicle each comprise an electrical and/or fluid connection box (27, 28), respectively a first electrical and/or fluid connection box (27) and a second electrical and/or fluid connection box (28). When they are connected, these boxes (27, 28) allow the coupled vehicles (2, 3) to share the electrical and/or fluid networks thereof.

The coupling device (1) according to the invention is preferably intended such that the first and second electrical and/or fluid connection boxes (27, 28) mutually engage during coupling of the two road vehicles (2, 3). This engagement of the two boxes (27, 28) can be automatic when the two road vehicles (2, 3) approach, or one of the boxes (27, 28) can be motorized in order to be moved towards the other box in order for the mutual connection thereof.

Centering means (29) may be provided between the two road vehicles (2, 3) to assure the centering of the two road vehicles (2, 3), which facilitates the automatic engagement of the boxes (27, 28). The centering means (29) are preferably in the form of cones (30) provided on the crossbar (10), and intended to enter into receiving houses (31) provided on the crossbar (6) when the two road vehicles (2, 3) are brought towards each other or the drawbar coupling (5) and the drawbar (6) are brought towards each other.

In order to better understand the invention, we are now going to describe the step-by-step operation of the two embodiments of the invention given as examples.

### First Embodiment Shown in FIGS. 8 to 10

FIG. 8 shows the approach phase, in which the coupling eye (7) is entirely outside and approaches the drawbar coupling (5). The mobile part (21) housed in the receiving housing (8) of the drawbar coupling (5) has the form of a swinging flap (32). It is constrained in vertical or oblique position in the drawbar coupling (5) by the second elastic pushing or return device (24), here in the form of a torsion spring (33). The free end (11) of the coupling pin (9) is butted against one of the lateral sides of the swinging flap (32), which prevents the entering of the coupling pin (9) of the drawbar coupling (5). Thus, the coupling pin (9) is retracted in unlocked position: the drawbar coupling (5) is ready to receive the coupling eye (7).

Guided and centered by the V-shaped opening of the drawbar coupling (5), the coupling eye (7) enters into the receiving housing (8) thereof (FIG. 9). The coupling eye (7) is centered in the drawbar coupling (5), in adequate position in order for locking thereof. The coupling eye (7) entering into the receiving housing (8) of the drawbar coupling (5) automatically raises the swinging flap (32), doing service as a device for detection (20) of the presence of the coupling eye (7). Since the swing flap (32) is raised, the side thereof is no longer butted against the free end (11) of the coupling pin (9), which is then automatically pushed into the receiving housing (8) of the drawbar coupling (5) by the coil spring (17).

The coupling eye (7) is locked in the drawbar coupling (5). The locking sensor (25) detects that the coupling eye (7) is correctly locked by the coupling pin (9).

The cylinder (34) housed in the drawbar (6) is actuated in retracted position for bringing the vehicles (2, 3) together. The mutual position thereof is guided and centered because of the centering means (29). The crossbar (10) and the drawbar (6) are then combined and tightly pressed against each other so as to form a single mechanical assembly (FIG. 10).

The two vehicles (2, 3) are then coupled and centered; the second electrical connection box (28) of the drawbar (6) can be moved towards the first electrical connection box (27) of the crossbar (10) in order to mutually connect them such that the coupled vehicles (2, 3) share their electrical and/or fluid networks.

The at least one locking sensor (25) detects that the coupling eye (7) is correctly locked by the coupling pin (9) and the drawbar coupling (6) is firmly combined with the crossbar (10). A signal is sent to the driver of the towing vehicle who knows that it is now possible to travel without risk of failure of the coupling.

The inverse operations serve to separate the two vehicles (2, 3). The withdrawal of the coupling pin (9) outside of the coupling eye (7) is done by pressurizing the jack (18) or, in case of hydraulic or pneumatic failure, by actuating the unlocking cable or threaded rod (26). During withdrawal of the coupling pin (9) outside the coupling eye (7) the coupling pin (9) comes out of the receiving housing (8) of the drawbar coupling (5), which allows the swinging flap (32) to automatically return to the substantially vertical or oblique equilibrium position thereof in the drawbar coupling (5) in order to block the coupling pin (9) in unlocked position.

### Second Embodiment Shown in FIGS. 11 to 15

FIG. 11 shows the approach phase, in which the coupling eye (7) is entirely outside and approaches the drawbar coupling (5). The drawbar coupling (5) is opened, meaning the coupling pin (9) is retracted in unlocked position: the drawbar coupling (5) is ready to receive the coupling eye (7).

Guided and centered by the V-shaped opening of the drawbar coupling (5), the coupling eye (7) enters into the receiving housing (8) thereof (FIG. 12). The coupling eye (7) is centered in the drawbar coupling (5), in adequate position in order for locking thereof. The at least one position sensor (22) detects the presence of the coupling eye (7) in the drawbar coupling (5).

Following the detection of the presence of the coupling eye (7), the at least one position sensor (22) actuates the displacement device (15) for locking. The pressure in the cylinder (18) is released and the coupling pin (9) enters into the coupling eye (7). This penetration is guided and facilitated by the substantially rounded or conical shape of the free end (11) of the coupling pin (9). The coupling eye (7) is locked in the drawbar coupling (5) (FIG. 13). The locking sensor (25) detects that the coupling eye (7) is correctly locked by the coupling pin (9).

The cylinder (34) housed in the drawbar (6) is actuated in retracted position for bringing the vehicles (2, 3) together. The mutual position thereof is guided and centered because of the centering means (29) (FIG. 14). The crossbar (10) and the drawbar (6) are then combined and tightly pressed against each other so as to form a single mechanical assembly.

The two vehicles (2, 3) are then coupled and centered; the second electrical connection box (28) of the drawbar (6) is moved towards the first electrical connection box (27) of the crossbar (10) in order to mutually connect them. Once this connection is established, the coupled vehicles (2, 3) share their electrical and/or fluid networks (FIG. 15).

The at least one locking sensor (25) detects that the coupling eye (7) is correctly locked by the coupling pin (9) and the drawbar coupling (6) is firmly combined with the crossbar (10). A signal is sent to the driver of the towing vehicle who knows that it is now possible to travel without risk of failure of the coupling.

The inverse operations serve to separate the two vehicles (2, 3). The withdrawal of the coupling pin (9) outside of the coupling eye (7) is done by pressurizing the jack (18) or, in case of hydraulic or pneumatic failure, by actuating the unlocking cable or threaded rod (26).

It is obvious that this description is not limited to the examples explicitly described, but also includes other embodiments and/or implementations. Thus, one described technical characteristic can be replaced by an equivalent technical characteristic without going outside the scope of the invention such as defined by the attached claims, and one described functional step of implementation of the method can be replaced by an equivalent step without going beyond the scope of the invention as defined by the claims.

1. A coupling device provided between a first and a second road vehicle for coupling these two road vehicles, these two road vehicles each comprising at least two axles, where said coupling device comprises:
a drawbar secured to the second road vehicle and comprising an end coupling eye; and
a crossbar secured to the first road vehicle and comprising a drawbar coupling intended to receive the coupling eye of the first road vehicle for locking during coupling of the two road vehicles;
where said coupling device comprises an automatic locking mechanism provided for automatically locking the coupling eye with the drawbar coupling when the coupling eye enters into the drawbar coupling following the coupling eye and the drawbar coupling coming close.

2. The coupling device according to claim 1, wherein the automatic locking mechanism comprises the following means:
a coupling pin provided in the crossbar of the first road vehicle, where this coupling pin is perpendicular to the drawbar coupling when the two road vehicles are coupled and is mobile between a locked position wherein the coupling pin enters into the drawbar coupling for passing through the coupling eye and an unlocked position in which the coupling pin releases the coupling eye such that the eye can be extracted from the drawbar coupling;
a displacement device provided in the crossbar of the first road vehicle for moving the coupling pin between the locked position thereof and the unlocked position thereof;
a detection device provided in the crossbar of the first road vehicle for detecting the presence of the coupling eye in the drawbar coupling, where said detection device automatically actuates the displacement device when the detection device detects the presence of the coupling eye in the drawbar coupling in order for the displacement device to move the coupling pin into the locked position thereof.

3. The coupling device according to claim 2, wherein the coupling eye is located in a vertical plane and the coupling pin is horizontal, or wherein the coupling eye is located in a horizontal plane and the coupling pin is vertical.

4. The coupling device according to claim 2, further comprising a command device which, when actuated by a user, commands the displacement device such that the displacement device moves the coupling pin into the unlocked position thereof.

5. The coupling device according to claim 2, further comprising an unlocking cable or threaded rod linked to the coupling pin and which moves the coupling pin into the unlocked position thereof when the unlocking cable or threaded rod is actuated by a user.

6. The coupling device according to claim 5, wherein the unlocking cable or threaded rod is connected to a screw accessible to a user, where this screw causes the longitudinal movement of the unlocking cable or threaded rod when the screw is turned.

7. The coupling device according to claim 2, wherein the displacement device comprises an elastic pushing or return device which forces the coupling pin in the direction of the drawbar coupling, the detection device comprises a blocking device which is housed in the drawbar coupling and prevents the coupling pin from entering into said drawbar coupling, where this blocking device is suited for coming into contact with the coupling eye during coupling of the two road vehicles, which would release the coupling pin which can then enter into said coupling eye within the drawbar coupling in order to mutually lock the two road vehicles.

8. The coupling device according to claim 7, wherein the blocking device comprises a mobile part in butted contact with the free end of the coupling pin, where this mobile part is kept in plugging position before the coupling pin by a second elastic pushing or return device, and where said mobile part is moved outside of the plugging position thereof when the mobile part comes into contact with the coupling eye.

9. The coupling device according to claim 2, wherein the displacement device comprises a cylinder.

10. The coupling device according to claim 9, wherein the cylinder is a single acting cylinder associated with a spring which pushes the rod of said cylinder into extended position and where the retracted position of the rod of the cylinder is obtained by putting said cylinder under pressure.

11. The coupling device according to claim 9, wherein the detection device comprises a position sensor or a mechanical device which, when the position sensor or the mechanical device detects the presence of the coupling eye in the drawbar coupling or when the position sensor or the mechanical device detects the proximity of said eye, causes operation of the cylinder by pushing of the coupling pin into the drawbar coupling or ends pressurizing of the cylinder if that is combined with an elastic pushing or return device, which causes the pushing of the coupling pin into the drawbar coupling.

12. The coupling device according to claim 2, wherein the coupling pin slides longitudinally in a housing comprising at least one receiving groove on the inner perimeter thereof and wherein the coupling pin comprises at least one locking part on the outer perimeter thereof intended for freely engaging in the at least one receiving groove when the coupling pin is inserted into the coupling eye, where this engagement of the at least one locking part in the at least one receiving groove longitudinally locks the coupling pin into position.

13. The coupling device according to claim 12, wherein the displacement device comprises a slider which enters to the inside of the coupling pin such that, when the displacement device moves the coupling pin into the locked position thereof, the slider pushes the at least one locking part outward so as to lock the at least one locking part in the at least one receiving groove.

14. The coupling device according to claim 1, wherein:
the crossbar secured to the first road vehicle comprises a first electrical and/or fluid connection box;
the drawbar secured to the second road vehicle comprises a second electrical and/or fluid connection box; and
the first and second electrical and/or fluid connection boxes are intended to engage with each other during coupling of the two road vehicles.

15. The coupling device according to claim 1, wherein the first road vehicle is a towing vehicle and the second road vehicle is a following vehicle.

16. A road vehicle comprising a coupling device according to claim 1.

17. A road vehicle according to claim 16, further comprising a drawbar at the front and a crossbar comprising a drawbar coupling at the rear.
